(19) United States
(12) Patent Application Publication
(10) Pub. No.: US 2023/0318080 A1
(43) Pub. Date: Oct. 5, 2023

(54) CELL ASSEMBLY, CELL SUB-MODULE, ENERGY STORAGE MODULE AND METHOD FOR ASSEMBLING THE SAME

(71) Applicant: Clarios Advanced Solutions GmbH, HANNOVER / NIEDERSACHSEN (DE)

(72) Inventors: Marco JANSEN, Celle (DE); Joerg BIRKHOLZ, Sarstedt (DE); Henning EISERMANN, Uetze (DE); Martin WIEGMANN, Borstel (DE); Ralf JOSWIG, Buchholz (DE)

(21) Appl. No.: 18/332,439

(22) Filed: Jun. 9, 2023

Related U.S. Application Data
(63) Continuation of application No. 16/616,587, filed on Nov. 25, 2019, now abandoned.
(60) Provisional application No. 62/513,606, filed on Jun. 1, 2017.

(51) Int. Cl. H01M 10/6554; H01M 10/613; H01M 10/647; H01M 10/04; H01M 10/48; H01M 50/296; H01M 50/284; H01M 50/271; H01M 50/267; H01M 50/211; H01M 50/569; H01M 50/516; H01M 50/507; H01M 50/51

(52) U.S. Cl. CPC H01M 10/6554; H01M 10/613; H01M 10/647; H01M 10/0481; H01M 10/482; H01M 50/296; H01M 50/284; H01M 50/271; H01M 50/267; H01M 50/211; H01M 50/569; H01M 50/516; H01M 50/507; H01M 50/51; H01M 2220/20

(57) ABSTRACT

A cell assembly having a cell frame, into which a thermal plate is integrated, a lithium-ion pouch cell having positive and a negative cell terminals in which the positive and negative cell terminals have a substantially planar shape and are arranged at a top side of the pouch cell. The positive and negative cell terminals extend at least substantially perpendicular from the top side of the pouch cell. The cell assembly has a compression element in which the cell frame is configured to receive and house the pouch cell and the compression element in a space defined by the thermal plate and the cell frame.

### CROSS-REFERENCE TO RELATED APPLICATION

This application is a continuation of U.S. application Ser. No. 16/616,587, filed Nov. 25, 2019, entitled “CELL ASSEMBLY, CELL SUB-MODULE, ENERGY STORAGE MODULE AND METHOD FOR ASSEMBLING THE SAME”, which claims priority to U.S. National Stage Patent Application of International Application No.: PCT/EP2018/064516, filed Jun. 1, 2018 entitled “CELL ASSEMBLY, CELL SUB-MODULE, ENERGY STORAGE MODULE AND METHOD FOR ASSEMBLING THE SAME,” which claims priority to U.S. Provisional Application No. 62/513,606, filed Jun. 1, 2017, entitled “POUCH CELL ARRANGEMENT AND CONTACTING WITH ULTRASONIC WELDING IN 12V LITHIUM-ION STARTER BATTERY,” the entireties of all of which are incorporated herein by reference.

### DESCRIPTION

The present disclosure relates generally to the field of energy storage cells and energy storage modules. More specifically, the present disclosure relates to lithium-ion cell assemblies that may be used in vehicular contexts, as well as other energy storage/expending applications. Furthermore, the present disclosure relates to a method for manufacturing/assembling such cell sub-modules, and energy storage modules, respectively.

This section is intended to introduce the reader to various aspects of the art that may be related to various aspects of the present disclosure, which are described and/or claimed below. The discussion is believed to be helpful in providing the reader with background information to facilitate a better understanding of the various aspects of the present disclosure. Accordingly, it should be understood that these statements are to be read in this light and not as admissions of prior-art.

A vehicle generally refers to any means of transportation using one or more battery system for providing a starting power and/or at least a portion of a motion power for the vehicle. The vehicle may refer to a motor-powered and/or electrically powered vehicle such as an air- or watercraft, a rail-guided vehicle, or preferably a street vehicle. The street vehicle may in particular refer to cars, trucks, buses or recreational vehicles.

In vehicles, different types of batteries are used, such as traction batteries (especially for electric or hybrid electric vehicles) and starter batteries. In automotive applications, a starter battery is used for providing the necessary energy/power required for starting a vehicle. In more detail, a starter battery generally refers to a battery or energy storage module, which provides at least a portion of the energy/power, preferably the total energy/power, required when starting a vehicle and/or required for providing power to vehicle-internal electrical systems (such as, e.g., lights, pumps, ignition and/or alarm systems).

Conventionally, 12 Volt (V) lead-acid batteries are used as starter batteries for vehicles. However, lead-acid batteries have a rather heavy weight, in particular, due to their low energy densities. Quite to the contrary, lithium-ion energy storage modules are known for their high energy densities. In addition, lithium-ion energy storage modules have, for example, a longer service life, less self-discharge, improved rapid charging capability and shorter maintenance intervals than conventional lead-acid batteries. However, the lithium-ion chemistry has different needs and requirements as the conventional lead-acid battery.

As battery technology evolves, there is a need to provide improved power sources, particularly energy storage modules for vehicles. For example, lithium-ion batteries or battery cells tend to be very susceptible to heating or overheating, which may negatively affect components of the energy storage module. Also, lithium-ion batteries or battery cells tend to be very sensitive with respect to overcharging and deep-discharging of the respective cells or battery.

Accordingly, an objective of the present application is to provide a cell assembly, a cell sub-module, and an energy storage module, which overcome the disadvantages of the conventional systems, and which are easy to manufacture, economical and versatile, and which can be easily adapted and assembled, while meeting the specific demands posed by a lithium-ion battery chemistry. A further objective is to provide a method for assembling such a cell sub-module and energy storage module, in an easy, flexible and cost efficient manner.

These objectives are solved by a cell assembly, a cell sub-module, an energy storage module and a method for assembling the same according to the independent claims. Advantageous embodiments are defined by the dependent claims.

In more detail, the objective is solved by a cell assembly, comprising a cell frame, into which a thermal plate is integrated, a lithium-ion pouch cell comprising positive and a negative cell terminals, wherein the positive and negative cell terminals have a substantially planar shape and are arranged at a top side of the pouch cell, and wherein the positive and negative cell terminals extend at least substantially perpendicular from the top side of the pouch cell, and a compression element, wherein the cell frame is configured to receive and house the pouch cell and the compression element in a space defined by the thermal plate and the cell frame.

According to another aspect, the pouch cell can be secured to the thermal plate by means of a supported or non-supported adhesive layer, which is at least partially applied on the thermal plate, preferably a glue layer. Thereby, a simplified tight positioning and securing of the pouch cell is achieved.

The inventive proposal to form the cell assembly such that the lithium-ion pouch cell and the compression element are received in a space defined by the cell frame and the integrated thermal element achieves an exceptionally compact design of the cell assembly, which can be realized easily and with only few standard components. Furthermore, the thermal management of the cell assembly can be ensured in a reliable way by means of a (rather) large contact surface between the lithium-ion pouch cell and the thermal plate.

According to another aspect, the compression element can comprise at least one foam layer.

According to another aspect, the thermal plate can be in-molded in the cell frame, which is preferably made of a polymeric material which increases the stability of the cell frame-bus bars-thermal plate arrangement and provides an easy and precise way for arranging the bus bars and thermal plate in the cell frame. Thereby, manufacturing time and costs, as well as material costs can be reduced.

According to another aspect, a bottom portion of the thermal plate can extend through a bottom wall of the cell frame, wherein the bottom portion of the thermal plate is preferably configured to connect to a thermal management feature. This ensures structural integrity of the cell frame and also enhances the thermal management of the cell assembly.

According to another aspect, the cell frame can comprise geometric features for supporting appropriate placement of the cell terminals.

In an embodiment, the geometric features can comprise recesses, which have a shape corresponding to the cell terminals of the pouch cell.

Furthermore, a cell sub-module is provided comprising at least two cell assemblies as described above, in particular three cell assemblies as described above, wherein the at least two cell assemblies are stacked such that the thermal plate of a first cell assembly contacts the compression element of an adjacent cell assembly, and such that the respective positive and negative cell terminals of each cell assembly are arranged on a first side of the cell sub-module and form a respective positive and negative cell terminal stack.

The inventive proposal to provide a cell sub-module comprising at least two cell assemblies, wherein the cell terminals of the respective cell assemblies form respective cell terminal stacks, ensures a simple but accurate electrical connection between the respective cell terminals, and at the same time an improved thermal management.

According to another aspect, the cell sub-module can comprise three cell assemblies.

According to another aspect, the positive and negative cell terminals of the outer cell assemblies are pre-formed such that they are bent towards the respective positive and negative cell terminal of the middle cell assembly forming a substantially right angle so that the positive cell terminals and the negative cell terminals of the three cell assemblies form the respective positive and negative cell terminal stack.

According to another aspect, ends of the respective cell terminals of the cell terminal stack are substantially aligned with each other.

Moreover, an energy storage module is provided comprising a housing, and a plurality of cell sub-modules as described above, which is arranged in the housing, wherein the housing comprises a plurality of cavities, each configured to receive a corresponding one of the plurality of cell sub-modules, the cavities being defined by either one wall of the housing and an internal partition of the housing or by at least two internal partitions of the housing.

The inventive proposal to form an energy storage module of a plurality of cell sub-modules each comprising two or more cell assemblies, achieves a highly versatile product. In more detail, the desired qualities (e.g. total voltage, total capacity, energy density etc.) of the energy storage module can be easily and cost efficiently adapted by providing a corresponding amount of cell sub-modules having a respective number of cell assemblies.

According to another aspect, a plurality of bus bars can be configured to electrically connect the cell terminal stacks of the plurality of cell sub-modules to each other.

According to another aspect, the energy storage module can further comprise a sense line for measuring the voltage of a cell assembly, and/or a cell sub-module of the plurality of cell sub-modules, wherein the sense line preferably further comprises at least one temperature sensor integrated into the sense line.

According to another aspect, the housing of the energy storage module is closable or closed by means of a cover.

According to another aspect, the energy storage module is a 12 Volt lithium-ion starter battery comprising four cell sub-modules, each cell sub-module preferably comprising three cell assemblies.

Furthermore, a method for assembling a cell sub-module is provided, comprising the steps of providing three cell assemblies, arranging the cell assemblies in a stack such that respective positive and negative cell terminals of each cell assembly are aligned and are spaced apart from each other by a predetermined distance, and pre-forming the respective negative and positive cell terminals of the cell assemblies to form a cell terminal stack, wherein pre-forming the respective positive and negative cell terminals of the cell assemblies comprises bending the respective positive and negative cell terminals of the outer cell assemblies towards the respective positive and negative cell terminal of the middle cell assembly at approximately right angles.

According to another aspect, pre-forming the cell terminals of the respective cell assemblies can comprise forming a bend in the cell terminal stack to support bending of the cell terminal stack. Thus, the stack of cell assemblies is on the one hand connected more securely and on the other hand a following bending step can be performed more easily.

According to another aspect, the method can further comprise cutting the cell terminal stack such that ends of the respective positive and negative cell terminals of the cell assemblies substantially align with each other.

According to another aspect, the method can further comprise the step of ultrasonically welding of the respective positive and negative cell terminals of the cell terminal stack.

Moreover, a method for assembling an energy storage module is provided, comprising the steps of assembling a plurality of cell sub-modules according as described above, arranging each of a plurality of cell sub-modules into a corresponding cavity in a housing of the energy storage module and electrically connecting the plurality of cell sub-modules in series by means of a plurality of bus bars.

According to another aspect, the bus bars and the cell terminal stack can be connected to each other by welding, in particular by ultrasonically welding.

According to another aspect, welding of the cell terminal stack and welding of the bus bars to the cell terminal stack can be performed in a single welding step, if the bus bars and the cell terminals are made of similar materials which use similar welding parameters.

According to another aspect, after welding the bus bars to the cell terminal stacks, the cell terminal stacks can be bent over together with the bus bars. Thus, the necessary height of an energy storage module can be reduced.

According to another aspect, the housing can be closed by arranging a cover element on the housing and welding the same to the housing.

According to another aspect, electrical components such as a relay, a printed circuit board, and one or more shunts can be arranged in the cover element.

According to another aspect, the cover element can be sealed with an end cover, which is welded, preferably laser welded or ultrasonically welded, to the cover element to form a cover.

### BRIEF DESCRIPTION OF THE DRAWINGS

These and other features, aspects and advantageous of the present disclosure will become better understood when the following detailed description is read with reference to the accompanying drawings in which like characters represent like parts throughout the drawings, wherein:

FIGS. 1a to 1d are perspective views of assembling steps of a cell assembly;

FIGS. 2a and 2b are perspective views of a cell sub-module;

FIGS. 3a to 3d are perspective views of method steps for welding the terminals of a cell sub-module;

FIG. 4 is a perspective view of preforming the cell terminals of a cell sub-module according to an exemplary embodiment;

FIG. 5 is a perspective view of bending the cell terminals of a cell sub-module;

FIGS. 6a to 6d are perspective views of various steps of the process of integrating the cell sub-modules into an energy storage module; and

FIGS. 7a to 7e are perspective views of closing the housing with a cover.

### DETAILED DESCRIPTION

It should be noted that terms such as “above”, “below”, “on top of”, and “beneath” may be used to indicate relative positions for elements (e.g., stacked components of the cell sub-module and energy storage module described below) and are not limiting embodiments to either of a horizontal or vertical stack orientation. Further, it should be noted that terms such as “above”, “below”, “proximate”, or “near” are intended to indicate the relative positions of two layers in the stack that may or may not be in direct contact with one another

Also, terms such as “top”, “bottom”, and “side” are configured to describe relative position with respect to the cell assembly 1, cell sub-module 100 and/or energy storage module 1000 in the mounted state (e.g. when mounted in a vehicle)

Additionally, the geometric references are not intended to be strictly limiting. For example, the use of the term “perpendicular” does not require an exact right angle, but defines a relationship that is substantially perpendicular, as would be understood by one of ordinary skill in the art. Similarly, for example, the term “parallel” used in reference to geometric relationships does not require a perfect mathematical relationship, but indicates that certain features are generally extending in the same directions. Additionally, the term “planar” is used to describe features that are substantially flat that does not require perfect mathematical planarity.

In more detail, “substantially parallel” and “substantially planar” means that an angle between ±10°, preferably ±5°, most preferably ±2° to an exact parallel or planar orientation are considered as substantially parallel or substantially planar. In the same sense, a “substantially perpendicular” or “substantially right” angle is considered as an angle of 800 to 110°, preferably 85° to 95°, most preferably 880 to 92°.

Lithium-ion battery systems such as used in automotive applications, may be used in conjunction with or as a replacement for lead-acid batteries traditionally used in vehicles.

Described herein are various embodiments and design features of lithium-ion cell assemblies 1 and cell sub-modules 100, which may be arranged in a lithium-ion energy storage module 1000 for use in an automobile or other motive environments.

Those cell assemblies 1, cell sub-modules 100 and energy storage modules 1000 can also be used in various different environments, e.g. recreational purposes (e-bikes, scooters etc.) and so forth.

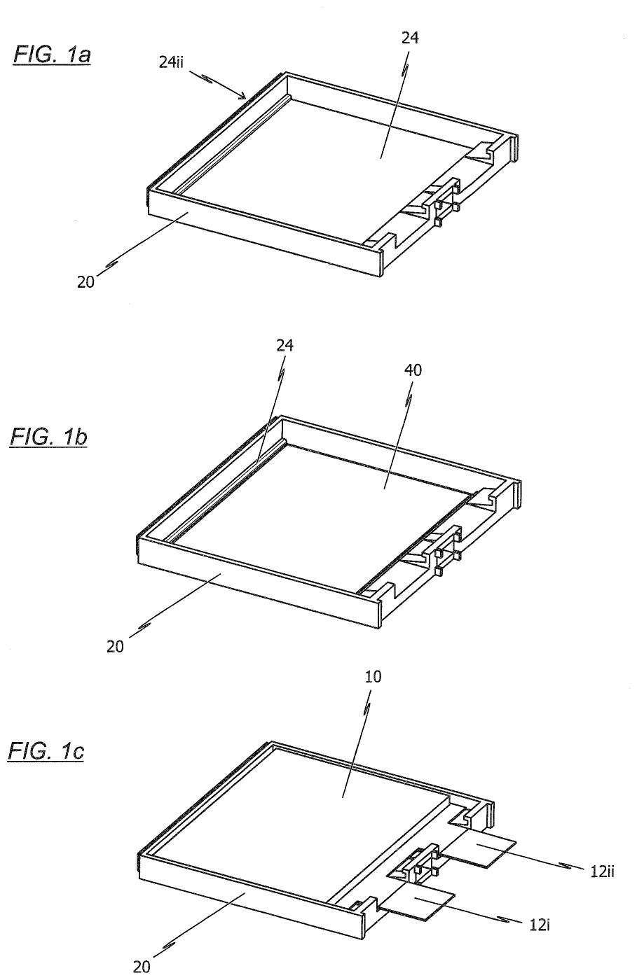

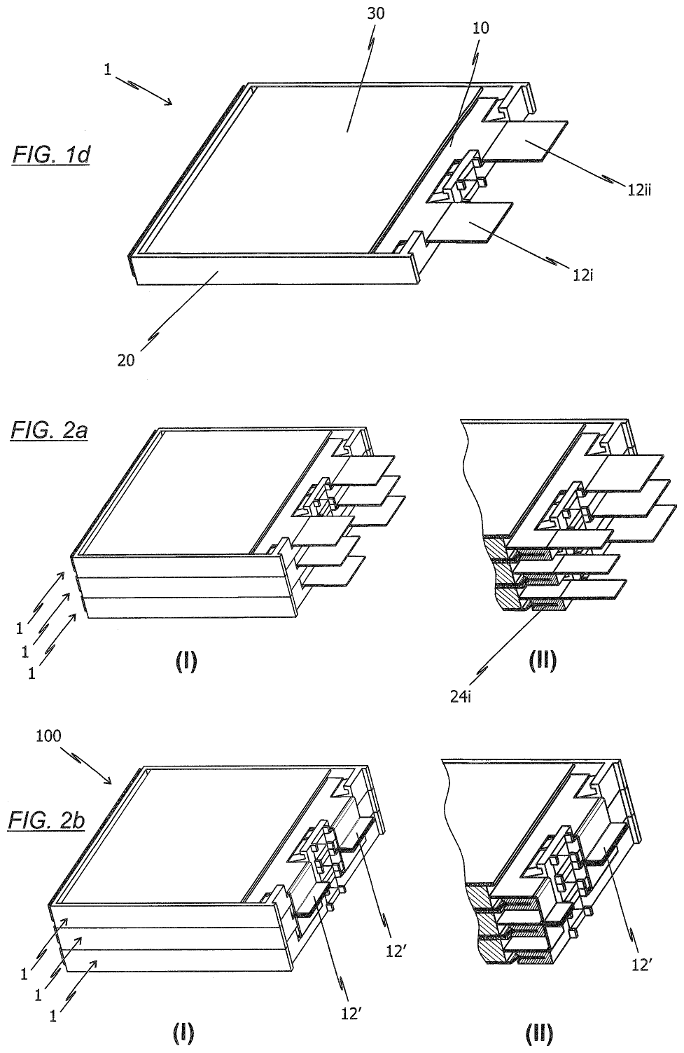

A perspective view of an embodiment of a cell assembly 1 is shown in FIG. 1d.

Therein, the cell assembly 1 includes a cell frame 20 for housing at least a lithium-ion pouch cell 10 and a compression element 30.

The cell frame 20 preferably comprises four side walls defining a space for receiving the pouch cell 10 and the compression element 30. In more detail, the cell frame 20 can comprise a top wall, a bottom wall opposite the top wall and two side walls connecting the top wall and bottom wall at respective ends. The top wall may be configured with recesses in order to receive and arrange the cell terminals of the lithium-ion pouch cell 10.

The cell element can be made of a polymeric material such as for example polyethylene, polypropylene, polyamide, polyimide, acrylnitril-butadien-styrol etc. and combinations thereof.

A thermal plate 24 for thermal management purposes can be in-molded into the cell frame 20. In some embodiments, the top wall of the cell frame 20 may be provided with gripping features (e.g. a slot) in which the thermal plate 24 is arranged (e.g. the thermal plate 24 may be in-molded into the cell frame 20).

The lithium-ion pouch cell 10 can be secured to the thermal plate 24 using an adhesive 40. The adhesive 40 can be provided in form of an adhesive layer, a supported or non-supported transfer tape layer, or by means of adhesive portions provided only at selective portions of the thermal plate 24.

The thermal plate 24 can be made of a thermally conductive material, in particular, a metal like aluminum, magnesium, copper, etc. In an embodiment, the thermal plate 24 can be made of aluminum and the surface facing the pouch cell 10 can be coated with aluminum oxide, which is electrically insulative.

The pouch cell 10 may include an outer electrically insulating layer (e.g. a polyimide film or another suitable electrically insulating polymer). Additionally, the pouch cell 10 may also include a metallic foil layer (e.g., an aluminum foil layer, or an aluminum oxide foil layer) that may provide enhanced structural integrity to be more resilient to pin holes deformities, to provide a better gas barrier layer, and so forth, compared to the use of insulating polymer films alone. Further, the pouch cell 10 can include an inner electrically insulating layer (e.g., a polyimide film or another suitable electrically insulating polymer) to electrically isolate the metallic foil layer from the internal components of the pouch cell 10. The above-described layers can be individually applied to the pouch cell 10 or may be provided as a single film including the layers, which may be collectively referred to as pouch material film.

The pouch material film may be sealed (e.g., sonically welded, sealed with epoxy, or another suitable seal) around the cell terminals 12i, 12ii to isolate the internal components of the pouch cell 10.

Inside the pouch cell 10, a positive cell terminal 12i may be electrically coupled to one or more cathode layers while the negative cell terminal 12ii may be electrically coupled to one or more anode layers. In certain embodiments the coupled layers may be made from an aluminum plate that are coated with a cathode active material (e.g., including a lithium metal oxide such as lithium nickel cobalt manganese oxide (NMC) (e.g., LiNiCoMnO₂), lithium nickel cobalt aluminum oxide (NCA) (e.g., LiNiCoAlO₂), or lithium cobalt oxide (LCO) (e.g., LiCoO₂)). In certain embodiments the anode layers may be made from copper plates that are coated with an anode active material (e.g., including graphite or graphene). It should be appreciated that these materials are merely provided as examples and that the present approach may be applicable to a number of differently lithium-ion and nickel metal hydride battery modules.

The at least one cathode layer and the at least one anode layer are configured to form an electrochemical stack which may be implemented as a “jelly roll”, wherein the positive cell terminal 12i and the at least one cathode layer may be formed from a single continuous strip of aluminum foil and the negative cell terminal 12ii and the at least one anode layer may be formed from a single, continuous strip of copper foil. For such an implementation, the aluminum foil strip and the copper foil strip may be stacked, along with a number of electrically insulating layers and wound to provide the electrochemical stack. In more detail, the aluminum foil strip and the copper foil strip may be stacked along with a number of electrically insulating layers and wound about a mandrel to provide the electrochemical stack.

Furthermore, an electrolyte (e.g., including carbonate solvents and LiPeF₆ as salt) is provided in the pouch cell 10. However, the present invention is not limited by a solvent (aqueous) electrolyte. Rather, a non-aqueous electrolyte can be used instead.

The negative cell terminal 12ii and the positive terminal 12i are preferably arranged on the same side of the pouch cell 10.

The negative and positive cell terminals 12i, 12ii are provided as respective terminal tabs.

The compression element 30 is arranged at a second planar face of the pouch cell 10, which is opposite to a first planar face contacting the thermal plate 24 via the adhesive 40. The compression element 30 can be formed as a foam layer. The compression element 30 helps to accommodate differences in sizes between the pouch cells 10 and furthermore serves to provide a minimum amount of compression such that the pouch cell 10 and the thermal plate 24 contact each other firmly; thus enhancing the thermal conduct.

Accordingly, the compression element 30 can equalize at least to some extent cell tolerances existing when manufacturing lithium-ion pouch cells 10

The cell assembly 1 as shown in FIG. 1 can be assembled or manufactured by inserting the thermal plate 24 into a molding tool, molding the cell frame 20 such as to integrate the thermal plate 24 into the cell frame 20, as shown in FIG. 1a, and applying an adhesive 40 to the surface of the thermal plate 24 facing the space for receiving the pouch cell 10 and the compression element 30 as shown in FIG. 1b. Then, the pouch cell 10 is inserted into the space such that the respective cell terminals 12i, 12ii are received by recesses formed in the cell frame 20, preferably in the top wall of the cell frame 20 as depicted in FIG. 1c.

Then, in FIG. 1d, a compression element 30 is inserted into the space of the cell frame 20. The compression element 30 can be provided as a cut sheet of a foam material. This sheet can be secured in the cell frame 20 either by means of an adhesive or by means of pressing the compression element 30 into the frame to form a press fit. Respective retaining features can therefore be provided in the cell frame 20 (e.g. in the sidewalls of the cell frame 20) in order to hold and retain the compression element 30 in the space. Alternatively, the compression element 30 could also be formed on the pouch cell 10 by directly applying the foam layer to the pouch cell 10. In other words, by foaming the layer on the pouch cell 10.

An exemplary compression element 30 could be made of a polyurethane, polypropylene, a polyethylene, a polystyrene, and/or a polyethylene terephthalate material.

The thermal plate 24 can be provided in form of a metal sheet or a metal oxide sheet (e.g. a sheet made of aluminum coated with aluminum oxide).

The cell frame 20 can be made of a polymeric material, in particular a thermoplastic material, and may include geometrical features to support appropriate placement of the cell terminals 12i, 12ii. In more detail, the top wall of the cell frame 20 can comprise two recesses configured to receive a respective cell terminal 12i, 12ii. The cell frame 20 may be made of a polyethylene, polypropylene, polyamide, polyimide, acrylnitril-butadien-styrol, etc. and combinations thereof.

The thermal plate 24 is integrated into the cell frame 20. In more detail, the thermal plate 24 can be in-molded or over-molded by the cell frame 20.

The thermal plate 24 may extend through the bottom wall of the cell frame 20 and may be bent at an approximately right angle such as to form a two-dimensional bottom portion 24ii parallel to and substantially covering the bottom wall of the cell frame 20. The bottom portion 24ii of the thermal plate 24 is configured for contacting a thermal management feature 50i of an energy storage module 1000. Thereby, heat can be conducted very efficiently to and from the pouch cell 10 from or to the thermal management feature 50i of the energy storage module 1000.

The top wall of the cell frame 20 can be over-molded on the thermal plate 24 such that at least a portion of a top portion 24i of the thermal plate 24 is received in a slot formed in the top wall of the cell frame 20. In some embodiments, one or more apertures or undercuts may be provided in the top portion 24i of the thermal plate 24 such that portions of the top wall of the cell frame 20 extend through the apertures in order to provide a secure fit of the thermal plate 24 in the cell frame 20.

Also, in a central area of the top wall of the cell frame 20, an opening can be defined, through which a portion of the top portion 24i of the thermal plate 24 can be accessible. Thereby, heat can be conducted to or from elements arranged above the cell assembly 1, when installed in an energy storage module 1000 for example.

As shown in FIGS. 1a to 1d, the method of forming a cell assembly 1 comprises the steps of providing a cell frame 20 with a thermal plate 24 in a first step. An adhesive layer is provided on the thermal plate 24 in a second step, followed by positioning of a lithium-ion pouch cell 10 within the cell frame 20 and against the adhesive 40 in a third step. In a fourth step, a compression element 30 is provided adjacent to the pouch cell 10 to provide for tolerance in cell size variations. Hence, a cell assembly 1 is formed which includes a cell frame 20, a thermal plate 24, an adhesive layer, a pouch cell 10 and a compression element 30. The compression element 30 may be a foam or at least one layer of foamed polymeric material

The adhesive layer, which is applied at step two, can be provided as a supported or non-supported adhesive layer, a double-sided glue tape, each covering at least partially the thermal plate 24. The adhesive 40 can also be applied only at portions of the thermal plate 24s, i.e., at selective points.

The terminals of the pouch cell 10 are preferably provided in form of terminal tabs.

After the formation of the cell assembly 1 as depicted in FIG. 1d, three of the cell assemblies 1 are stacked together in step five, as shown in FIG. 2a (I). The cell assemblies 1 are stacked together such that the positive and negative cell terminals 12ii of the cell assemblies 1 in the stack have a predetermined relationship relative to one another. I.e., the respective positive and negative cell terminals 12i, 12ii of the cell assemblies 1 in the stack are spaced apart from one another by a predetermined distance.

FIG. 2a (II) illustrated a sectional view of the stack of three cell assemblies 1 of FIG. 2a (I). The top portion 24i of the thermal plate 24 is illustrated therein in more detail. As shown, at least portions of the top portion 24i of the thermal plate 24 is received in a slot of the cell frame 20 formed during molding of the cell frame 20. In more detail, the portions of the top portion 24i of the thermal element received in the slot are portions arranged at respective positions where the cell terminals 12i, 12ii of the pouch cell 10 are located in the cell assembly 1.

FIG. 2 shows a perspective view of a stack of cell assemblies 1, which produces a cell sub-module 100. Therein, three cell assemblies 1 are arranged in a stack such that the cell terminals 12i, 12ii of a first cell assembly 1 substantially align with the cell terminals 12i, 12ii of an adjacent cell assembly 1. The three cell assemblies 1 are stacked such that the thermal plate 24 of a first cell assembly 1 faces and preferably contacts the compression element 30 of a second adjacent cell assembly 1.

In step six, the negative cell terminals 12ii of the cell assemblies 1 in the stack are connected to one another, and the positive cell terminals 12i of the cell assemblies 1 in the stack are connected to one another, respectively, to form respective negative and positive cell terminal stacks 12′ as shown in FIG. 2b.

Although only cell sub-modules 100 comprising three cell assemblies 1 are shown, a cell sub-module 100 may comprise any suitable number of cell assemblies 1 greater than or equal to two cell assemblies 1, which result in a desired requirement of the cell sub-module 100 (e.g., total voltage or total capacity of the cell sub-module 100).

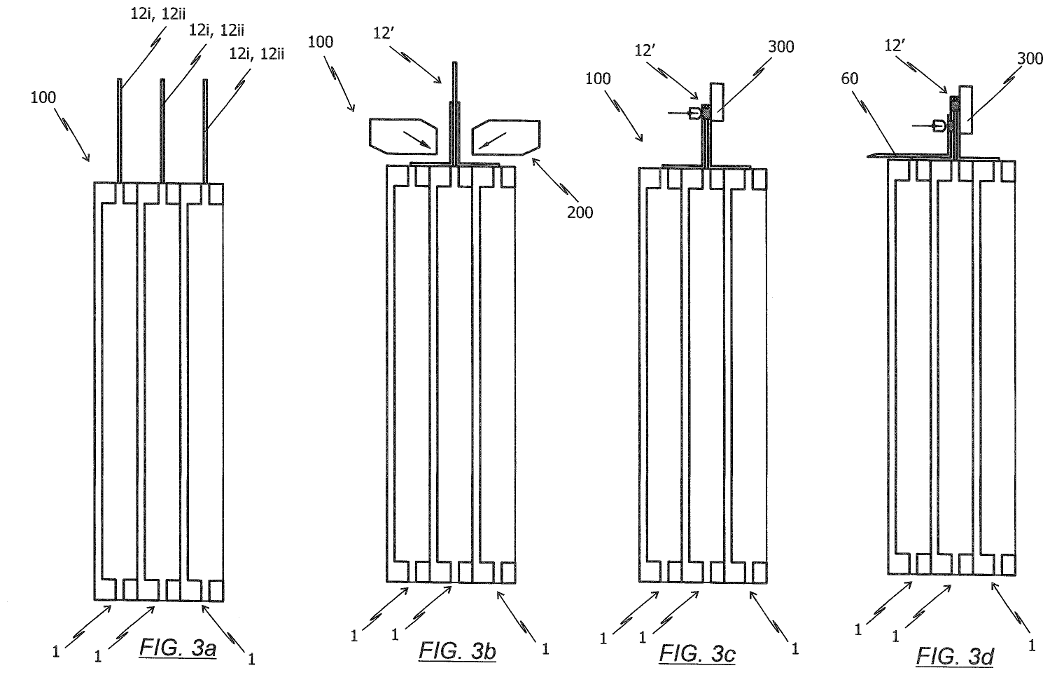

FIG. 3 shows an exemplary process of connecting the cell terminals 12i, (or 12ii), to one another and to bus bars 60.

Firstly, the cell assemblies 1 are stacked, as shown in a schematic view in FIG. 3a, followed by pre-forming of the cell terminals 12i, 12ii. The pre-forming step may also involve cutting one or more of the cell terminals 12i, 12ii so that when pre-formed (e.g., bent) together, the cell terminal ends are approximately aligned as shown in FIG. 3c.

Then, the cell terminals 12i, (or 12ii), are ultrasonically welded together, followed by placement of one or more bus bars 60.

Afterwards, as shown in FIG. 3d, the bus bars 60 are ultrasonically welded to the cell terminals 12i, 12ii.

The ultrasonically welding is performed using an ultrasonical welding tool 300.

If the bus bars 60 and the cell terminals 12i, 12ii are made out of similar materials and/or the materials of the cell terminals 12i, 12ii and of the bus bars 60 can be welded using similar parameters, the welding of the cell terminals 12i, 12ii to one another and the welding of the bus bars 60 to the cell terminal stacks 12′ can be performed in one step.

For pre-forming the cell terminals 12i, 12ii, a pre-forming tool 200 is used which presses the two outermost cell terminals 12i, 12ii and bends the same in the direction of the middle cell terminal 12i, 12ii such that the outermost cell terminals 12i, 12ii form substantially right angles.

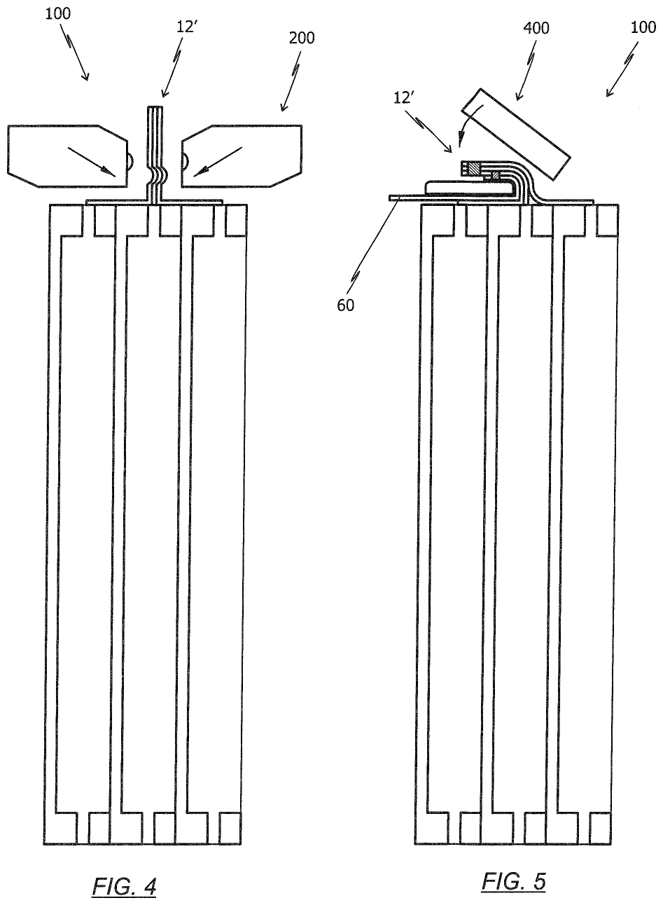

Then, the terminal ends of the cell terminals 12i, 12ii are cut such that they are approximately aligned as shown, e.g., in FIGS. 3c and 4.

FIG. 4 shows an alternative pre-forming step as shown in FIG. 3b. In more detail, the pre-forming of the cell terminals 12i, 12ii may be performed as shown in FIG. 4, to include a bend to support a following bending step. Therefore, the pre-forming tool 200 includes a recess on one tool part and a protrusion on the respective other tool part, wherein the contour of the protrusion and of the recess correspond to each other.

FIG. 5 shows a further step of the process of connecting the cell terminals 12i, (or 12ii), to one another in a cell sub-module 100, namely a bending step. In this regard, the cell terminals 12i, (or 12ii), which are ultrasonically welded to one another to form the cell terminal stack 12′ and optionally to a bus bar 60, are bent over (together with the bus bar 60). It should be noted that bending is not necessary, if sufficient height above the cell sub-module 100 is available.

In step six, the bending is performed by using a bending tool 400.

A plurality of such cell sub-modules 100 are configured to form an energy storage module 1000. In more detail, at least two, e.g., four, cell sub-modules 100 are arranged into a casing of an energy storage module 1000.

The casing comprises a housing 50 having internal partitions 52 in order to form respective cavities for receiving a corresponding one of the at least two cell sub-modules 100 and a cover 80 for closing the housing 50.

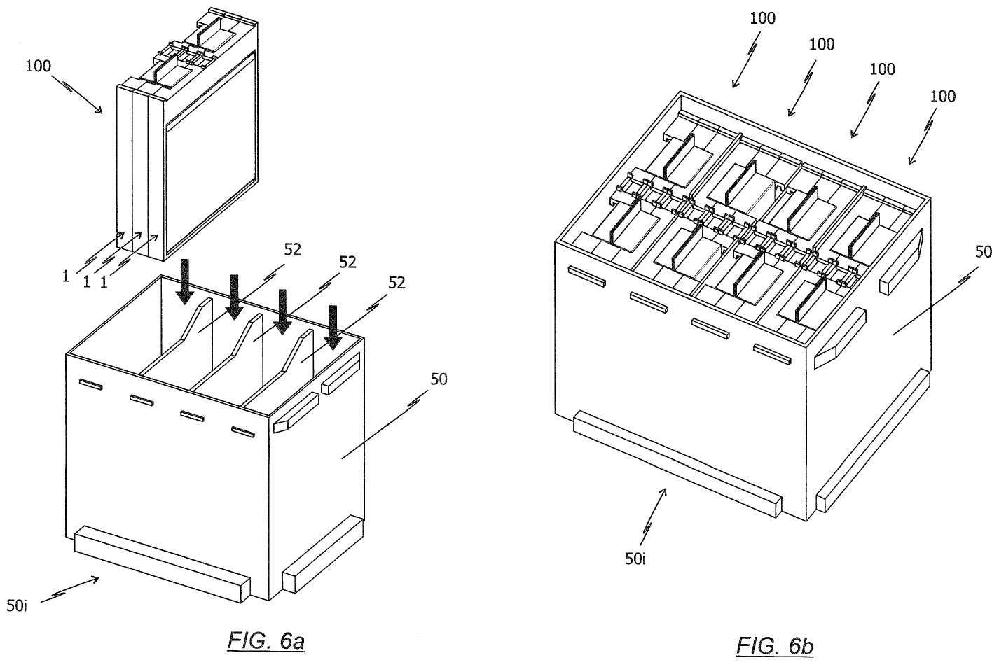

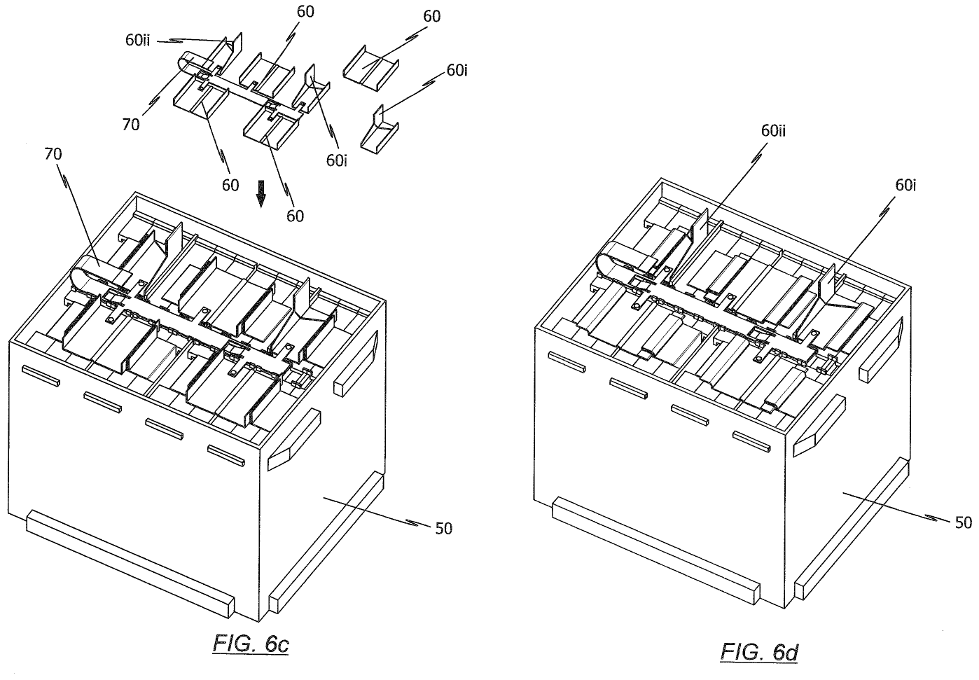

FIG. 6a shows an exemplary housing 50 of an embodiment of the present application. In this regard, the housing 50 comprises four side walls, three partition walls defining four cavities for receiving a respective cell sub-module 100. Furthermore, a thermal management feature 50i is provided at the bottom of the housing 50. The thermal management feature 50i may be a metallic heat sink, e.g. an aluminum heat sink, to support passive cooling of the respective cell sub-modules 100 and thereby of the respective cell assemblies 1.

FIG. 6b shows the housing 50 of FIG. 6a, wherein four cell sub-modules 100 are placed within each corresponding cavity. Each cell sub-module 100 may be fixed by means of the partition walls and/or an epoxy layer or a thermal paste provided on the thermal management feature 50i.

The cell sub-modules 100 can be arranged such that the negative cell terminals 12ii of a first cell sub-module 100 align with the positive cell terminals 12i of a second adjacent cell sub-module 100.

As shown in FIG. 6c, the plurality of cell sub-modules 100 can then be electrically coupled by means of a plurality of bus bars 60, which are configured to connect two adjacent cell sub-modules 100.

Moreover, a positive end connection piece 60i and a negative end connection piece 60ii are provided for electrically connecting the electrically connected cell sub-modules 100 with respective positive and negative main terminals 82i, 82ii of the energy storage module 1000. The main terminals 82i, 82ii are provided in the cover element for connection to electronics.

The bus bars 60 and the positive and negative end connection pieces 60i, 60ii may be welded to the cell terminals 12i, 12ii, respectively, by ultrasonic welding.

A sense line 70 may be connected and secured to the cell sub-modules 100 and the plurality of bus bars 60. The sense line 70 can include voltage and/or temperature sense features, such as e.g. a voltage sensor and/or a temperature sensor.

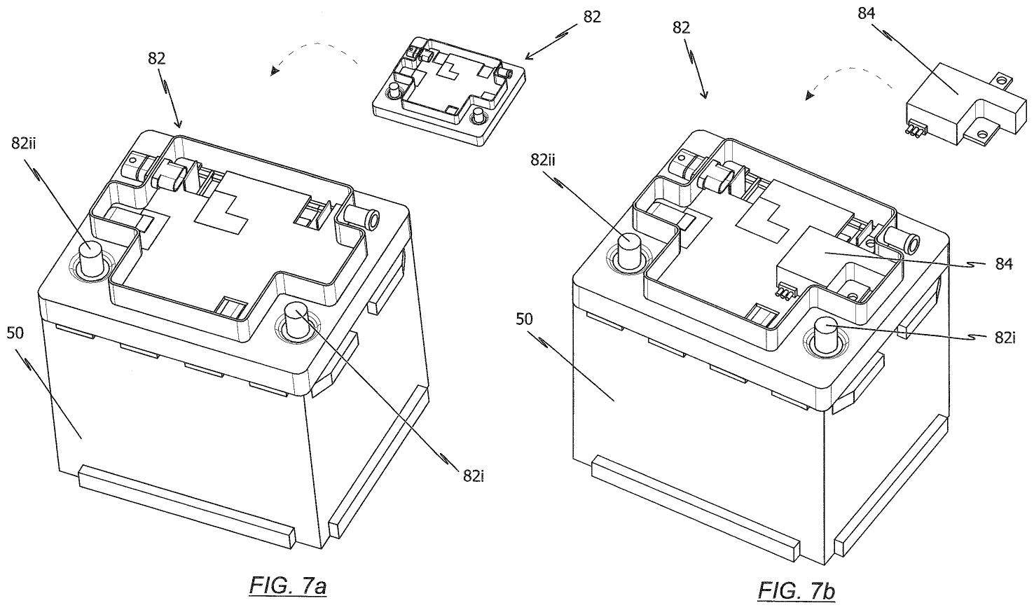

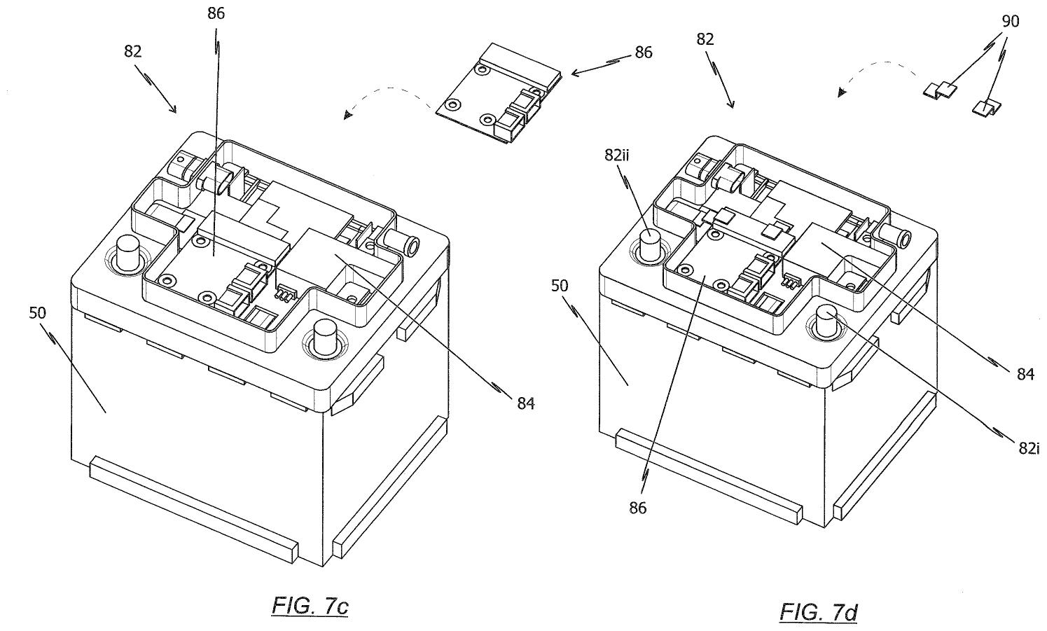

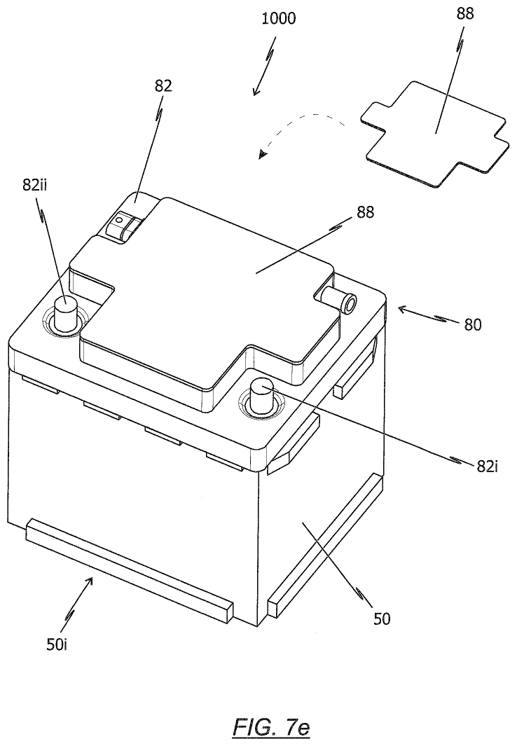

In more detail, FIGS. 6 and 7 depict various steps of the process of integrating the cell assemblies 1 and cell sub-modules 100 into the energy storage module 1000.

As shown in FIG. 6, the method of assembling the energy storage module 1000 includes in a first step as depicted in FIG. 6a, providing a housing 50 with a thermal management feature 50i. Then, a layer of epoxy is applied into the housing 50 and onto the thermal management feature 50i. The housing 50 further comprises a plurality of internal partitions 52 defining respective cavities within the housing 50. The cavities are configured for respectively receiving a corresponding one of the at least two cell sub-modules 100.

The arrows illustrated in FIG. 6a indicate the insertion direction of the respective cell sub-modules 100 into the cavities (although only one exemplary cell sub-module 100 is shown in FIG. 6a).

As shown in FIG. 6b in a second step, four cell sub-modules 100 are positioned in the housing 50. In other words, a respective cell sub-module 100 is positioned in a corresponding cavity of the housing 50. Then, the epoxy is cured to secure the cell sub-modules 100 in the housing 50.

As depicted in FIG. 6c, in a third step, bus bars 60, voltage and temperature sense features are welded to the cell sub-modules 100. In more detail, a sense line 70 comprising voltage and temperature sensing means and a plurality of bus bars 60 are arranged on the cell sub-modules 100 and are welded to the same. Also, a positive end connection piece 60i and a negative end connection piece 60ii of the bus bars 60 are electrically coupled to the respective positive or negative cell terminal stack 12′ of the first and the last cell sub-module 100 for electrically coupling the cell sub-modules 100 to respective positive and negative main terminals 82i, 82ii of the energy storage module 1000.

The insertion of the bus bars 60 and positive and negative end connection pieces 60i, 60ii is indicated by the arrow depicted in FIG. 6c. Therein, for illustration purposes, a sense line 70 together with the plurality of bus bars 60 and the positive and negative end connection pieces 60i, 60ii are illustrated separately and before arrangement in the energy storage module 1000.

As depicted in FIG. 6d, in a fourth step, the bus bars 60 are bend to accommodate the cover 80 of the battery. This step can be omitted, if the space above the cell sub-modules 100 is sufficient to accommodate the bus bars 60 and cell terminals 12i, 12ii in a non-bent form.

As shown in FIG. 7, a cover element 82 having an integrated connector barrel for connecting internal and external signal connectors, the main terminals 82i, 82ii and venting features, is welded to the housing 50 as shown in FIG. 7a. For example, the cover element 82 may be laser-welded or ultrasonically welded to the housing 50.

As shown, at this point, the cover element 82 has certain electrical features that are exposed. Such exposure enables follow-on integration of certain sensitive electronic features, such as relay 84 mounting (cf. FIG. 7b) and printed circuit board (PCB) 86 mounting (cf. FIG. 7c) in steps 6 and 7, respectively.

As shown in FIG. 7d, in step eight, one or more shunts 90 are welded between the PCB 86 and bus bars 60 electrically connected to the cell assemblies 1 in the housing 50.

As shown in FIG. 7e in step nine, an end cover 88 is welded to the cover element 82 to seal the electronics from the environment.

In this regard, the cover element 82 and the end cover 88 form the cover 80 of the energy storage module 1000. Such welding may be laser welding or ultrasonically welding.

In FIGS. 7a to 7e, the dotted arrow indicates the process of inserting the respective element.

In a preferred embodiment, the energy storage module 1000 is a 12V lithium-ion starter battery, comprising four cell sub-modules 100 electrically connected in series and each comprising three stacked cell assemblies 1 electrically connected in parallel as described above.

It should be understood that the invention is not limited in its application to the details of construction and arrangements of the components set forth herein. In more detail, depending upon the desired voltage and/or capacity of the energy storage module 1000, any suitable number of cell sub-modules 100 or cell assemblies 1 can be used in order to meet the desired demands.

The technical effects and technical problems in the specification are exemplary and are not limiting. It should be noted that the embodiments described in the specification may have other technical effects and may have other technical problems.

While only certain features and embodiments of the invention have been illustrated and described, many modifications and changes may occur to those skilled in the art (e.g. variations and sizes, dimensions, structures, shapes, proportions of the various elements, values of parameters, mounting arrangements, use of materials, colors orientations, etc.) without materially departing from the novel teachings and advantageous of the subject-matter recited in the claims. The order or sequence of any process or method steps may be varied or re-sequenced according to alternative embodiments.

What is claimed is:

1. A cell sub-module comprising at least a first cell assembly and two adjacent cell assemblies;
the two adjacent cell assemblies comprising:
a first adjacent cell assembly comprising a first adjacent pouch cell, the first adjacent pouch cell comprising a first adjacent positive cell terminal and a first adjacent negative cell terminal each having a substantially planar shape;
a second adjacent cell assembly comprising a second adjacent pouch cell, the second adjacent pouch cell comprising a second adjacent positive cell terminal and a second adjacent negative cell terminal each having a substantially planar shape; and
the first cell assembly comprising:
a cell frame having a top wall and a bottom wall opposite the top wall; and
a first pouch cell comprising a positive cell terminal and a negative cell terminal, the positive and negative cell terminals having a substantially planar shape and being arranged at a top side of the first pouch cell, the positive and negative cell terminals extending from the top side of the first pouch cell, the positive cell terminal forming a positive cell terminal stack including the positive cell terminal welded to the first and second adjacent positive cell terminals, the negative cell terminal forming a negative cell terminal stack including the negative cell terminal welded to the first and second adjacent negative cell terminals, the welded negative cell terminal stack and the welded positive cell terminal stack each being bent at a substantially right angle with respect to the top wall of the cell frame.

2. The cell sub-module according to claim 1, wherein the first cell assembly further comprises a thermal plate integrated into the cell frame, the thermal plate having a bottom portion and a top portion opposite the bottom portion.

3. The cell sub-module according to claim 2, further comprising a compression element, the cell frame being configured to receive and house the first pouch cell and the compression element in a space defined by the thermal plate and the cell frame.

4. The cell sub-module according to claim 3, wherein the compression element comprises at least one foam layer.

5. The cell sub-module according to claim 4, wherein the bottom portion of the thermal plate extends through the bottom wall of the cell frame and the top portion of the thermal plate being accessible through an aperture in the top wall of the cell frame, the bottom portion of the thermal plate being configured to contact a thermal management feature.

6. The cell sub-module according to claim 5, wherein the thermal plate is in-molded in the cell frame.

7. The cell sub-module according to claim 6, wherein the first pouch cell is secured to the thermal plate by one of a supported layer and a non-supported adhesive layer, which is at least partially applied on the thermal plate.

8. The cell sub-module according to claim 1, further comprising a sense line for measuring a voltage of the cell sub-module.

9. The cell sub-module according to claim 1, wherein the first cell assembly is sandwiched by the first and second adjacent cell assemblies.

10. The cell sub-module according to claim 1, wherein each of the first pouch cell and the first and second adjacent pouch cells is a lithium-ion pouch cell.

11. The cell sub-module according to claim 1, wherein the cell frame comprises at least one geometric feature supporting placement of a corresponding one of the positive cell terminal stack and the negative cell terminal stack, the at least one geometric feature having a recess having a shape corresponding to the corresponding one of the positive cell terminal stack and the negative cell terminal stack.

12. A method for assembling a cell sub-module comprising a middle cell assembly and two outer cell assemblies, the middle cell assembly comprising a middle positive cell terminal and a middle negative cell terminal, the two outer cell assemblies each comprising an outer positive cell terminal and an outer negative cell terminal, the method comprising:
arranging a positive cell terminal stack and a negative cell terminal stack formed by the respective positive and negative cell terminals of each cell assembly being aligned and spaced apart from each other by a predetermined distance; and
pre-forming the respective positive and negative cell terminal stacks of the cell assemblies by bending the respective outer positive and negative cell terminals of the outer cell assemblies towards the respective middle positive and negative cell terminals of the middle cell assembly at approximately right angles.

13. The method according to claim 12, wherein pre-forming the respective positive and negative cell terminal stacks comprises forming a bend in each of the positive cell terminal stack and the negative cell terminal stack to support bending of each of the positive cell terminal stack and the negative cell terminal stack.

14. The method according to claim 13, further comprising cutting each of the positive cell terminal stack and the negative cell terminal stack such that a plurality of ends of the respective positive and negative cell terminals of the cell assemblies substantially align with each other.

15. The method according to claim 14, further comprising ultrasonically welding together the respective positive and negative cell terminals of each of the positive and negative cell terminal stacks.

16. The method according to claim 15, further comprising welding a first bus bar to the positive cell terminal stack and a second bus bar to the negative cell terminal stack.

17. The method according to claim 12, wherein the middle cell assembly further comprises:
a cell frame; and
a thermal plate integrated into the cell frame, the thermal plate having a bottom portion and a top portion opposite the bottom portion.

18. The method according to claim 17, wherein the middle cell assembly comprises a compression element and a pouch cell, the method further comprising inserting the pouch cell and the compression element in a space defined by the thermal plate and the cell frame.

19. The method according to claim 18, wherein the compression element comprises at least one foam layer.

20. The method according to claim 19, further comprising in-molding the thermal plate in the cell frame.
